(19) United States
(12) Patent Application Publication
(10) Pub. No.: US 2008/0315747 A1
(43) Pub. Date: Dec. 25, 2008

(54) Electron emitting element, electron gun, and electron beam applied equipment using the same

(75) Inventors: Makoto Okai, Tokorozawa (JP); Tadashi Fujieda, Mito (JP); Kishio Hidaka, Hitachiota (JP); Mitsuo Hayashibara, Hitachinaka (JP); Shun-ichi Watanabe, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/076,888

(22) Filed: Mar. 25, 2008

(30) Foreign Application Priority Data
Mar. 30, 2007 (JP) 2007-090135

(51) Int. Cl. H01J 29/46

(52) U.S. Cl. 313/441

(57) ABSTRACT

An electron emitting element having a cap portion 103 with a closed structure and a columnar axis portion 101a comprising a tubular material composed mostly of carbon and a conductive base material for immobilizing the tubular material, characterized in that; the cap portion 103 includes a plurality of five-membered ring structures 104 made by atoms which constitute the tubular material and the distance between the five-membered ring structures 104 is 30 nm or more.

### CLAIM OF PRIORITY

The present application claims priority from Japanese application serial No. 2007-090135, filed on Mar. 30, 2007, the content of which is hereby incorporated by reference into this application.

### BACKGROUND OF THE INVENTION

1. Field of the Invention

The present invention relates to an electron emitting element, electron gun, and electron beam applied equipment using the same, such as an electron microscope.

2. Description of Related Art

In an electron microscope and an electron beam lithography system, which use a carbon nanotube composed mostly of carbon as an electron source, the angular current density is high and highly luminous electron beams can be obtained (Japanese Patent Application Laid-open No. 2004-79223 (Patent Document 1)).

In order to narrow the energy linewidth of an electron emitted by an electron emitting element which uses tubular material composed mostly of carbon, a method of doping fibrous carbon material with nitrogen and boron is described in Japanese Patent Application Laid-open No. 2006-49293 (Patent Document 2).

Patent Document 1: Japanese Patent Application Laid-open No. 2004-79223

Patent Document 2: Japanese Patent Application Laid-open No. 2006-49293

### SUMMARY OF THE INVENTION

In view of the above technology, an object of the present invention is to provide an electron emitting element having a narrower energy linewidth. Also, an object of the present invention is to provide a high-luminance electron gun, a high-resolution electron microscope or a high-resolution electron beam lithography system.

To solve the above-mentioned problems, the present invention is, as described in claims, characterized by a carbon nanotube specifically comprising a substantially cylindrical axis and a substantially hemispherical cap (closed structural region), wherein the cap area is constructed by an array of atoms of five-membered rings and six-membered rings, and the arrangement of the five-membered rings has been prescribed. Specifically, the present invention is characterized in that a carbon nanotube having a closed structural region in the end portion thereof wherein the distance between five-membered rings located in the closed structural region is 30 nm or more is used for an electron beam emitting element. Also, the present invention is characterized in that a carbon nanotube having a closed structural region in the end portion thereof wherein a vertex angle with a five-membered ring in the closed structural region at the vertex is 70 degrees or more is used for an electron beam emitting element. While investigating how to achieve an electron source having a narrow energy linewidth, the inventors verified that electrons are selectively emitted from the vicinity of the five-membered ring. Furthermore, energy dispersion due to the space electron repulsion increases the energy linewidth of an electron beam. Therefore, by disposing five-membered rings at distances wider than a prescribed value, it is possible to reduce space electron repulsion and decrease energy dispersion, thereby achieving an electron emitting element having a narrow energy linewidth.

According to the present invention, it is possible to reduce energy dispersion effects caused by the space electron repulsion and the concentration of electric fields and provide an electron emitting element having high luminance and narrow energy linewidth. Also, it is possible to provide a high-resolution electron microscope or a high-resolution electron beam lithography system.

### BRIEF DESCRIPTION OF THE DRAWINGS

FIG. 1(a) is a schematic vertical cross-section of a carbon nanotube to show a principle of the present invention.

FIG. 1(b) is a drawing to show a top surface of the outermost layer of the closed structural region of the carbon nanotube shown in the FIG. 1(a).

FIG. 2(a) is a schematic drawing to show how electron beams are emitted from a carbon nanotube.

FIG. 2(b) is a schematic drawing to show an example of a conical structure having a narrow vertex angle with a five-membered ring at the vertex.

FIG. 2(c) is a schematic drawing to show an example of a conical structure having a wide vertex angle with a five-membered ring at the vertex.

FIG. 3(a) shows a pattern of an electron emission from a multi-wall nanotube observed on a fluorescent plate.

FIG. 3(b) is a schematic drawing to show an arrangement of the five-membered rings in the closed structural region in the case of the pattern of FIG. 3(a).

FIG. 3(c) shows another pattern of an electron emission from a multi-wall nanotube observed on a fluorescent plate.

FIG. 3(d) is a schematic drawing to show an arrangement of the five-membered rings in the closed structural region in the case of the pattern of FIG. 3(c).

FIG. 4(a) shows the simulation results of the energy linewidth of the emitted current in the case in which the distance between five-membered rings in the closed structural region are changed.

FIG. 4(b) shows the simulation results of the energy linewidth of the emitted current in the case in which the vertex angle of the conical structure with a five-membered ring in the closed structural region at the vertex is changed.

FIG. 5 is a schematic drawing to show a configuration of an electron gun of a first embodiment in the present invention.

FIG. 6 is a schematic drawing to show a configuration of a magnetic field immersion type electron gun of a second embodiment in the present invention.

FIG. 7 is a schematic drawing to show a configuration of a scanning electron microscope of a third embodiment in the present invention.

FIG. 8 is a schematic drawing to show a configuration of an electron beam lithography system of a fourth embodiment in the present invention.

### DETAILED DESCRIPTION OF THE PREFERRED EMBODIMENTS

An electron element according to the present invention comprises a tubular material having an electron emission site for emitting electrons and a conductive base material for immobilizing a tubular material and applying voltage so that the tubular material can emit electrons. Tubular material composed mostly of carbon, such as a carbon nanotube made of carbon or a heterocarbon nanotube which substitutes some part of carbon of the carbon nanotube with nitrogen or boron, is used for an electron element according to the present invention. The tubular material used for an electron element of the present invention comprises a hollow or solid tubular columnar axis and a cap whose end portion is a closed structure. The present invention is characterized in that a distance between five-membered rings located in the cap of the tubular material is 30 nm or more. Also, an angle made by the tube and the surface of the cap of the tubular material of the present invention is 70 degrees or more, specifically, 100 degrees or more.

In the case in which a carbon nanotube emits an electron beam, a five-membered ring made of carbon located in the end portion of the cap functions as an electron emission site. There are six five-membered rings in the cap. If the distances between those five-membered rings are narrow, the direction of electron beams changes due to the space electron repulsion of electron beams emitted from each five-membered ring. Therefore, the energy linewidth of the emitted electron beams becomes wide because of the energy dispersion effects. By making a carbon nanotube thick and increasing distances between the five-membered rings, it is possible to prevent the increase of the energy linewidth. Furthermore, conventionally, there is a problem in that it is difficult to increase luminance while suppressing the energy linewidth because the energy linewidth increases as the luminance increases. According to the present invention, it is possible to increase luminance while suppressing the energy linewidth when compared to the conventional technology.

As the result of the increase of the distances between the five-membered rings, the columnar axis of the tubular material tends to become thick. When an electron beam is emitted from the end portion of the tubular material, high voltage is applied to the end portion due to the concentration of electric fields. Furthermore, the equipotential plane becomes dense due to the concentration of electric fields. Because an electron beam is emitted vertically to the equipotential plane, there is a problem in that directions of electron beams emitted from the end portion are not constant. However, it is preferable that the tubular material be thick because the concentration of electric fields becomes eased as the tubular material becomes thick. As a result, it is possible to further narrow the energy linewidth. Moreover, the cross-section of a thin tubular material appears to be like a circular. However, as the tubular material becomes thicker, it tends to appear to be a polygonal (pentagon, hexagon, or the like).

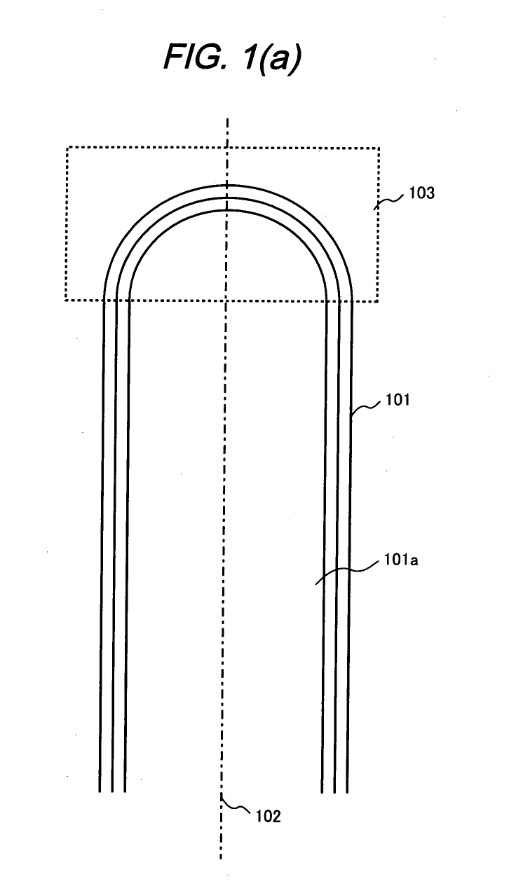

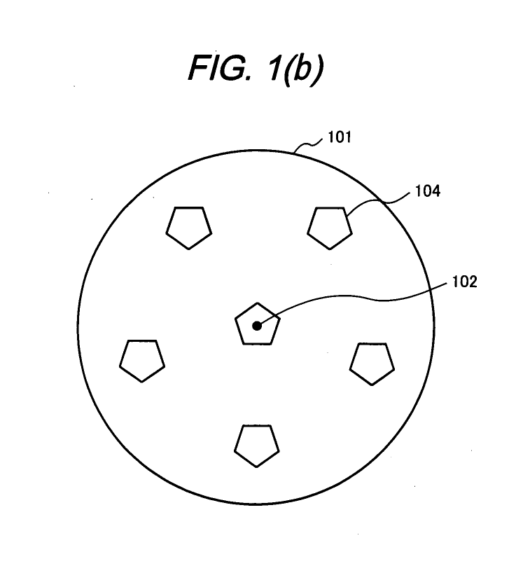

The principle of the present invention will be described with reference to FIGS. 1, 2, 3, and 4. FIG. 1(a) shows a schematic vertical cross-section of a carbon nanotube. A carbon nanotube is a tubular material made of carbon. FIG. 1(a) shows a structure example in which the tubular structure is a triply nested structure. A tube which has a multiply nested structure is called a “multi-wall nanotube,” and a tube which has a single tube is called a “single-wall nanotube.” A multi-wall nanotube, which has a nested structure of tenfold or more is mechanically strong and allows large current to flow; therefore, it is desirable that such a multi-wall nanotube be applied to an electron source. FIG. 1(a) shows an ideal structure in which the closed structural region (cap portion) 103 is a hemispherical and is a rotation symmetry with regard to the central axis 102 located in the length direction of a columnar axis portion 101a in the carbon nanotube 101. Actually, the closed structural region is asymmetric in many cases.

FIG. 1(b) shows a top surface of the outermost layer of the closed structural region of a carbon nanotube 101. For a nanotube to form a closed structure, geometrically, at least six five-membered rings must be located in the closed structural region. Although FIG. 1(b) shows only six five-membered rings 104 in a pentagon, the other part of the carbon nanotube 101 is ideally constructed by six-membered rings of carbon atoms. FIG. 1(b) shows an ideal structure in which one five-membered ring 104 is located at the center of the closed structural region and five five-membered rings 104 are disposed with equal distances.

The number of five-membered ring arrangement patterns increases as a diameter of a nanotube increases, and it is not possible for the current manufacturing technology to accurately control the locations of the five-membered rings. However, a nanotube having a large diameter can be created according to a conventional manufacturing method, and it is possible to observe the shape of the end portion of nanotubes and select a nanotube in which distances between five-membered rings are large.

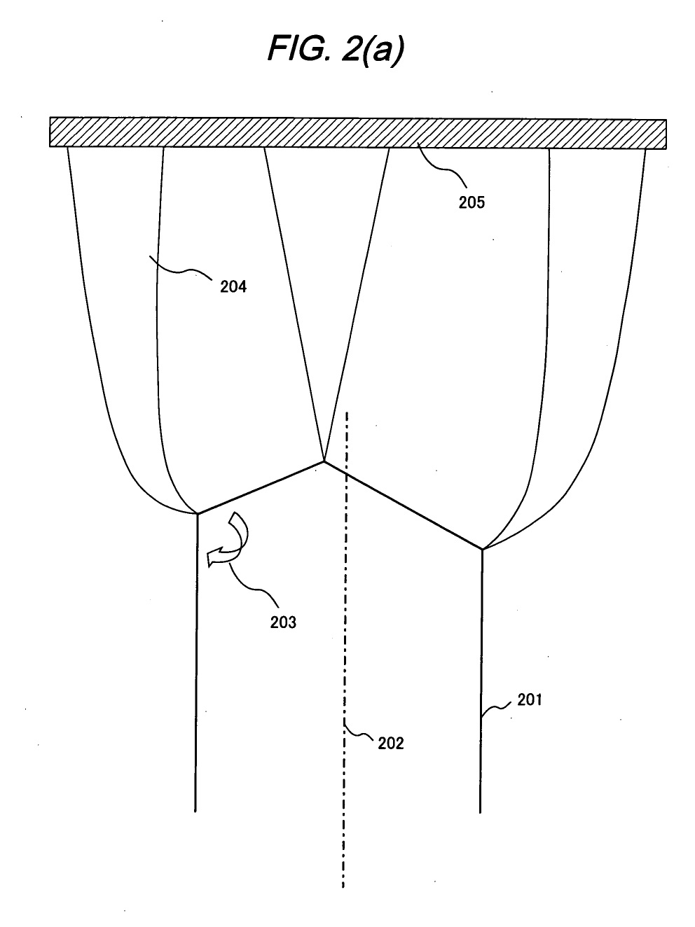

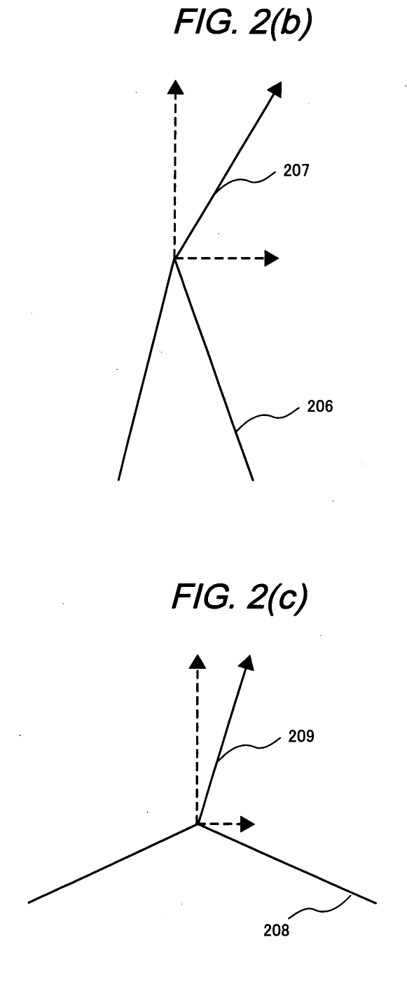

FIG. 2(a) is a schematic drawing to show how electrons are emitted from a carbon nanotube. Only the outermost layer 201 of the carbon nanotube is shown. FIG. 2(a) shows an example in which a closed structure of a carbon nanotube is asymmetric with regard to the central axis 202 in the length direction of the nanotube. In the case in which the diameter of the outermost layer 201 of the carbon nanotube is 30 nm or more (relatively thick), the cross-section of the nanotube becomes a polygonal, and the closed structural region of the nanotube has a substantially multangular conic structure with a five-membered ring at the vertex. A vertex angle 203 made by the nanotube portion and the cap portion of the nanotube increases as distances between five-membered rings increase, and the vertex angle 203 can approximate to a computationally stable 113 degrees.

Because the work function near the five-membered rings in the closed structural region of the carbon nanotube is smaller than that of six-membered rings, it is considered that electrons are emitted selectively from the vicinity of the five-membered rings. FIG. 2(a) shows the situation in which electrons emitted from the vicinity of the five-membered rings are oriented to the fluorescent plate 205 to which plus voltage is applied along the electron trajectory 204. When distances between the electron trajectories are small, energy disperses due to the space electron repulsion, thereby increasing the energy linewidth. As stated above, electrons are emitted only from the vicinity of the five-membered rings in a carbon nanotube; therefore, it is desirable that distances between five-membered rings be large in order to reduce energy dispersion effects due to the space electron repulsion.

FIG. 2(b) is a schematic drawing to show a conical structure 206 in which a vertex angle of the end portion of the carbon nanotube with a five-membered ring at the vertex is narrow. Since the five-membered ring is located at the vertex of a conical structure, energy dispersion effects caused by the concentration of electric fields influence. To reduce the energy dispersion effects, it is desirable that the vertex angle of the conical structure be as wide as possible. The direction 207 of the electric field in the vicinity of the vertex is significantly away from the vertical direction because of the intense concentration of electric fields, thereby increasing energy dispersion effects in the vertical direction. FIG. 2(c) shows a conical structure 208 in which a vertex angle of the end portion with a five-membered ring at the vertex is wide. The direction 209 of the electric field is close to the vertical direction even in the area away from the vertex, thereby decreasing the energy dispersion effects in the vertical direction.

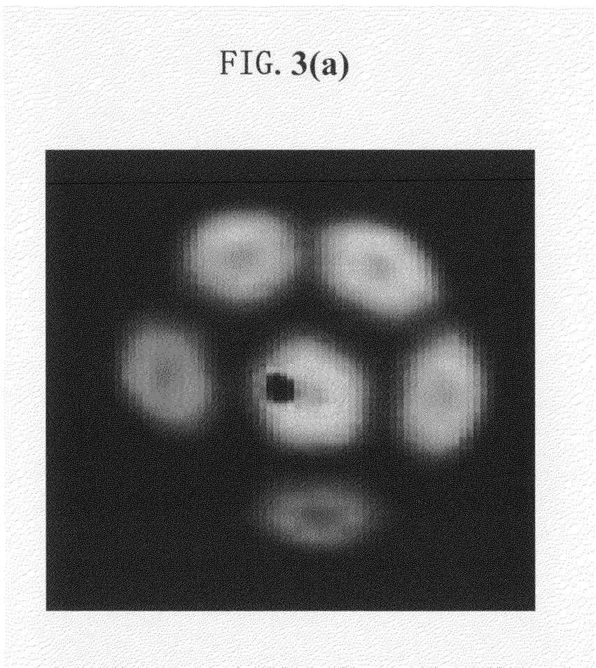

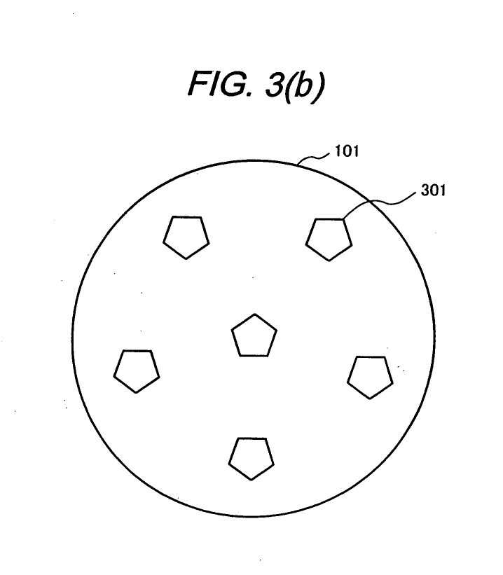

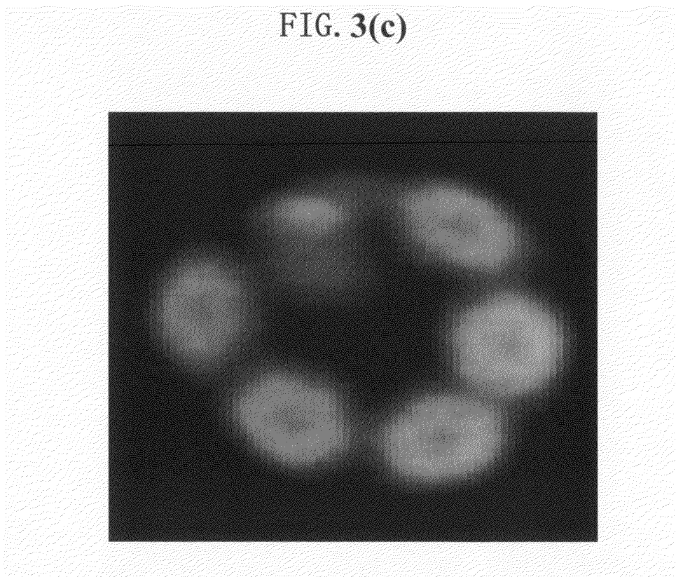

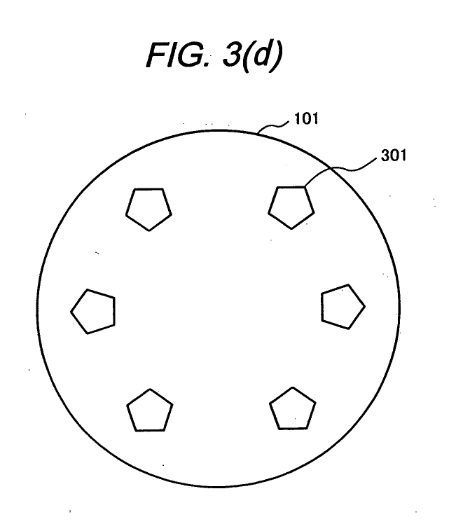

FIG. 3 shows that electrons are emitted from the vicinity of the five-membered rings in the closed structural region of a carbon nanotube. FIG. 3(a) shows the results of observation in which a pattern of an electron emission from a multi-wall nanotube having a diameter of 30 nm is observed on a fluorescent plate. One five-membered ring pattern located at the center and five five-membered ring patterns around the center were observed. A black round hole shown on the left of the central five-membered ring pattern is an electron intake hole created on the fluorescent plate. A nanotube 101 having five-membered rings 301 in the closed structural region as shown in FIG. 3(b) is considered to have an electron emission pattern shown in FIG. 3(a). Furthermore, a nanotube 101 having five-membered rings 301 in the closed structural region as shown in FIG. 3(d) is considered to have an electron emission pattern shown in FIG. 3(c). As evidenced by a location of the electron intake hole, an electron beam emitted from a five-membered ring closet to the central axis is used. Therefore, in view of easy use, it is preferable that the distance between the central axis of the carbon nanotube and the five-membered ring closest to the central axis be small. If the distance is 30 nm or less, it is practically no problems with an electron microscope or the like, and it is desirable that the distance be 10 nm or less.

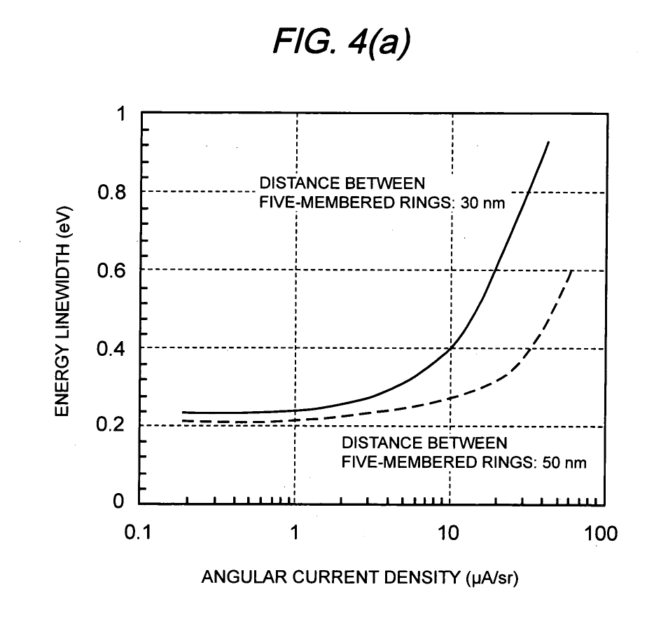

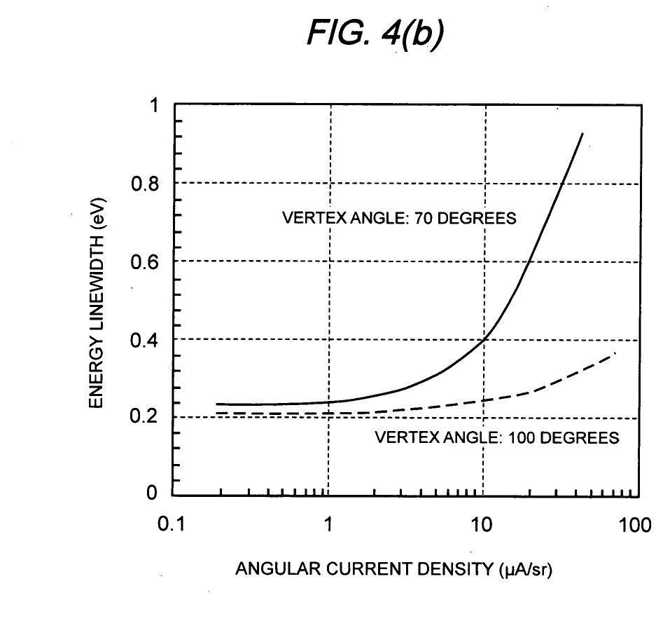

FIG. 4(a) shows the simulation results of the energy linewidth of the emitted current in the case in which the distance between five-membered rings in the closed structural region are changed. The energy linewidth is shown by using a value of the full-width at half-maximum as a function of the angular current density. For example, in the case in which the angular current density is 10 μA/sr, the energy linewidth is 0.4 eV as shown by the solid line when the distance between five-membered rings is 30 nm, and the energy linewidth can be narrower, 0.28 eV as shown by the dashed line, when the distance between five-membered rings is 50 nm. Moreover, in a carbon nanotube approximately 10-nm thick, the energy linewidth is 0.8 eV when the angular current density is between 2 and 3 μA. Therefore, as the distance between five-membered rings increases, luminance (angular current density) can be made large while keeping the energy linewidth narrow. In the case in which the minimum distance of a plurality of five-membered rings is 30 nm, the same effects were obtained as the effects obtained by using an electron emitting element that uses tungsten. Furthermore, when the distance between five-membered rings is 50 nm or more, it is possible to highly inhibit the increase of the energy linewidth.

Furthermore, FIG. 4(b) shows the simulation results of the energy linewidth of the emitted current in the case in which the vertex angle of the conical structure with a five-membered ring in the closed structural region at the vertex is changed. For example, in the case in which the angular current density is 10 μA/sr, the energy linewidth is 0.4 eV as shown by the solid line when a vertex angle is 70 degrees, and the energy linewidth can be narrower, 0.24 eV as shown by the dashed line, when the vertex angle is 100 degrees. Furthermore, those results were verified experimentally. Accordingly, it is preferable that the vertex angle of the conical structure of the carbon nanotube with a five-membered ring at the vertex be 70 degrees; furthermore, it is desirable that the vertex angle be 100 degrees or more. Moreover, computationally, strain is less when an angle around the five-membered ring is 113 degrees. Accordingly, it is more preferable that the vertex angle be 113 degrees or more.

As stated above, in order to narrow the energy linewidth of an electron emitted from a carbon nanotube, it is considered that increasing the distances between the five-membered rings in the closed structural region is effective. By increasing the distances between five-membered rings, energy dispersion effects due to the space electron repulsion can be reduced. Furthermore, by increasing the distances between the five-membered rings, a vertex angle of the conical structure of the carbon nanotube with a five-membered ring at the vertex can be wide, thereby making it possible to reduce energy dispersion effects caused by the concentration of electric fields.

Furthermore, it is preferable that the tubular material for the carbon nanotube contain group-3 or group-5 of chemical elements, such as boron, nitrogen, and the like, in addition to carbon. Including those chemical elements is effective to narrow the energy linewidth.

Since the five-membered ring exists at the vertex of the conical structure in the closed structural region of the carbon nanotube, the distance between the five-membered rings can be determined by observing the closed structural region at different angles by the use of a transmission electron microscope. Furthermore, it is possible to accurately determine a vertex angle of the conical structure by the observation using a transmission electron microscope.

### Embodiment 1

### Configuration Example 1 of the Electron Gun

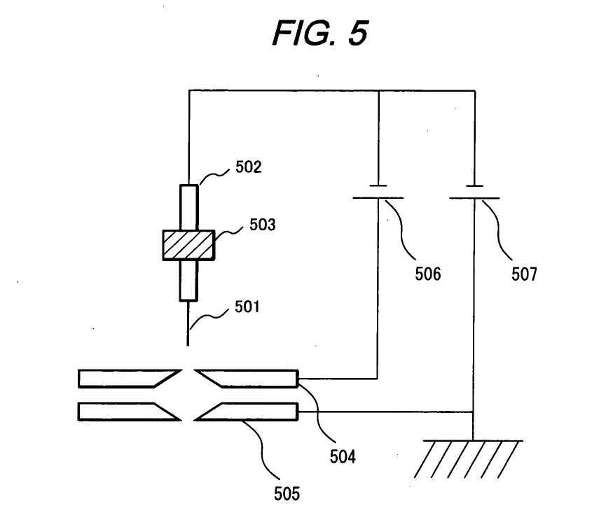

FIG. 5 shows a schematic configuration of the embodiment of an electron gun according to the present invention. An electron gun of the embodiment comprises a cathode electrode including a conductive base material 501, an electrode 502, and an electrode support 503; a drawing electrode 504 for emitting electrons from the cathode electrode; and an accelerating electrode 505 for accelerating electrons. An electron emitting element is bonded to the conductive base material 501 to form one unit. The drawing electrode 504 applies plus voltage to the cathode electrode from the drawing electrode power source 506. Furthermore, the accelerating electrode 505 applied plus voltage to the cathode electrode from the accelerating electrode power source 507. This embodiment can constitute an electron gun having high luminance and narrow energy linewidth.

### Embodiment 2

### Configuration Example 2 of the Electron Gun

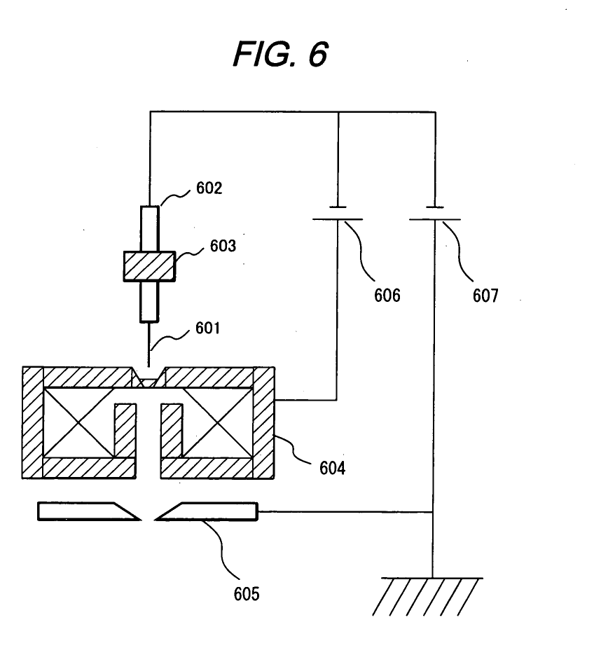

FIG. 6 shows a schematic configuration of another embodiment of an electron gun according to the present invention. The basic structure of the electron gun is almost the same as that of the electron gun shown in FIG. 5. This embodiment of an electron gun in which a magnetic lens 604 having little spherical aberration is used instead of using the drawing electrode 504 included in the electron gun shown in FIG. 5. This type of electron gun is called a “magnetic field immersion type electron gun.”

The electron gun of this embodiment comprises a cathode electrode including a conductive base material 601, an electrode 602, and an electrode support 603; the magnetic lens 604 for emitting electrons from the cathode electrode; and an accelerating electrode 605 for accelerating electrons. An electron emitting element is bonded to the conductive base material 601 to form one unit. The magnetic lens 604 applies plus voltage to the cathode electrode from the drawing electrode power source 606. And the accelerating electrode 605 applied plus voltage to the cathode electrode from the accelerating electrode power source 607. By the use of the magnetic lens 604, it is possible to focus the electron beam thereby reducing the spatial expansion of the beam. According to this embodiment, it is possible to provide an electron gun having high luminance and narrow energy linewidth as in the same manner as the electron gun shown in FIG. 5.

### Embodiment 3

### Configuration Example 1 of the Scanning Electron Microscope

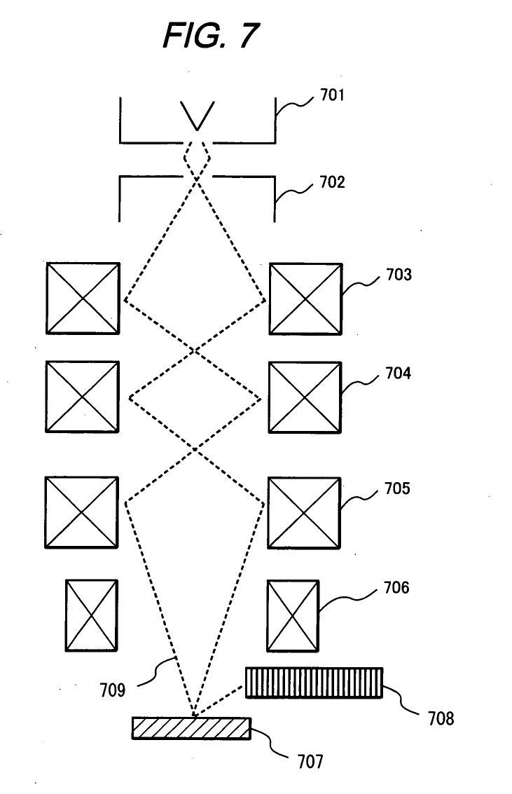

FIG. 7 shows a schematic configuration of an embodiment of a scanning electron microscope according to the present invention. FIG. 7 also shows electron trajectories 709. The scanning electron microscope is equipped with an electron gun 701, an anode electrode 702 for processing an electron beam emitted from the electron gun 701, a first conversing lens 703, a second conversing lens 704, and an objective lens 705; and the scanning electron microscope further comprises a scanning coil 706 for scanning an electron beam and a secondary electron detector 708 for detecting a secondary electron emitted from a sample 707. A carbon nanotube according to the present invention is used for the electron gun 701. Inside of the electron microscope is kept in high vacuum condition. By operating the electron microscope, enlarged images of a sample 707 can be obtained. It is also possible to provide a sample position adjustment means in an electron microscope of this embodiment so that the sample 707 can be mechanically moved or rotated without touching the sample from outside of the electron microscope.

A scanning electron microscope of this embodiment can obtain high-resolution and high-luminance secondary electron images and reflected electron images. Furthermore, since luminance is high, scanning speed can be increased; consequently, electron images can be obtained quickly. When a scanning electron microscope of this embodiment is used for observing microscopic machining patterns or measuring dimensions during a semiconductor processing procedures, it is possible to use significantly microscopic specimens. Furthermore, the configuration of the electron microscope is not intended to be limited to the configuration shown in FIG. 7, and other configurations, such as a transmission electron microscope, scanning transmission electron microscope, and the like, can be used to obtain the same effects.

### Embodiment 4

### Example of the Electron Beam Lithography System

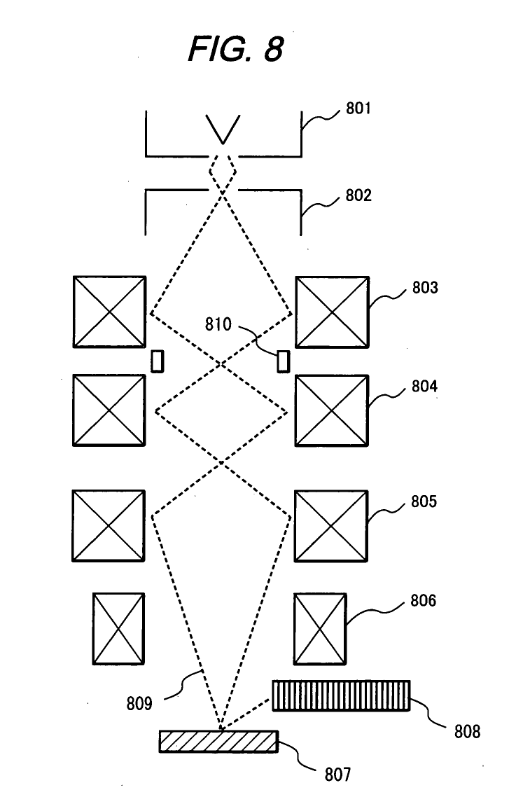

FIG. 8 shows a schematic configuration of an embodiment of an electron beam lithography system according to the present invention. FIG. 8 also shows electron trajectories 809. The basic electron optical structure is almost the same as that of the scanning electron microscope shown in FIG. 7, and the electron beam lithography system comprises an electron gun 801, an anode electrode 802 for processing an electron beam emitted from the electron gun 801, a first conversing lens 803, a second conversing lens 804, and an objective lens 805; and the electron beam lithography system further comprises a scanning coil 806 for scanning an electron beam and a secondary electron detector 808 for detecting a secondary electron emitted from a sample 807. The electron beam lithography system further comprises a blanker 810, disposed between the first conversing electrode 803 and the second conversing electrode 804, for turning on and off electron beams.

The electron beam lithography system emits a narrowed electron beam onto a sample 807 on which an electron beam resist sensitive to an electron beam is applied, thereby forming a microscopic pattern. The electron beam lithography system according to this embodiment can emit an electron beam having a significantly small diameter; therefore, significantly microscopic patterns can be plotted. Furthermore, the high luminance electron beam can increase throughput.

What is claimed is:

1. An electron emitting element having a cap portion with a closed structure and a columnar axis portion comprising a tubular material composed mostly of carbon and a conductive base material for immobilizing the tubular material, characterized in that;
the cap portion includes a plurality of five-membered ring structures made by atoms which constitute the tubular material and the distance between the five-membered ring structures is 30 nm or more.

2. The electron emitting element according to claim 1, wherein
the tubular material has a multilayer structure, and the outermost layer of the cap portion has a plurality of five-membered ring structures, and the distance between a five-membered ring closest to the central axis in the direction of the length of the columnar axis portion and another five-membered ring closest to the five-membered ring is 30 nm or more.

3. The electron emitting element according to claim 1, wherein
an distance between the five-membered ring structures is 50 nm or more.

4. The electron emitting element according to claim 2, wherein
the distance between the central axis and a five-membered ring closest to the central axis is 30 nm or less.

5. An electron emitting element having a cap portion with a closed structure and a columnar axis portion comprising a tubular material composed mostly of carbon and a conductive base material for immobilizing the tubular material, characterized in that;
the cap portion includes a plurality of five-membered ring structures made by atoms which constitute the tubular material and a vertex angle made by a five-membered ring closest to the central axis in the direction of the length of the columnar axis portion is 70 degrees or more.

6. An electron emitting element having a cap portion with a closed structure and a columnar axis portion comprising a tubular material composed mostly of carbon and a conductive base material for immobilizing the tubular material, characterized in that;
an angle made by the cap portion and the surface of the columnar axis portion is 70 degrees or more.

7. The electron emitting element according to claim 5, wherein
the angle is 100 degrees or more.

8. The electron emitting element according to claim 1, wherein
the tubular material includes a group-3 or a group-5 of chemical element.

9. An electron gun comprising a negative electrode using an electron emitting element, a drawing electrode for emitting an electron from the negative electrode, and an accelerating electrode for accelerating the electron emitted from the negative electrode, characterized in that;
the electron emitting element is an electron emitting element according to claim 1.

10. An electron microscope comprising an electron gun, a lens for focusing an electron beam emitted from the electron gun, and a secondary electron detector for detecting a secondary electron emitted from a specimen onto which the electron beam is irradiated, characterized in that;
the electron gun is an electron gun according to claim 9.

11. An electron beam lithography system comprising an electron gun, a lens for focusing an electron beam emitted from the electron gun, and a scanning coil for scanning the electron beam, characterized in that;
the electron gun is an electron gun according to claim 9.

12. An electron gun comprising a negative electrode using an electron emitting element, a drawing electrode for emitting an electron from the negative electrode, and an accelerating electrode for accelerating the electron emitted from the negative electrode, characterized in that;
the electron emitting element is an electron emitting element according to claim 5.
